(19) United States
(12) Patent Application Publication
(10) Pub. No.: US 2006/0227532 A1
(43) Pub. Date: Oct. 12, 2006

(54) Keypad lighting arrangement

(75) Inventors: Youngwook Ko, Daejeon-Si (KR); Namheon Lee, Daejeon-Si (KR); Seungsik Hong, Chungbuk (KR)

Correspondence Address: JENKENS & GILCHRIST, P.C., 901 15TH STREET N.W., SUITE 900, WASHINGTON, DC, 20005, US

(73) Assignee: KDT Co. Ltd., Chung-Woon Gun (KR)

(21) Appl. No.: 11/369,970

(22) Filed: Mar. 8, 2006

(30) Foreign Application Priority Data
Apr. 6, 2005 (KR) 10-2005-0028463

(51) Int. Cl. F21V 33/00

(52) U.S. Cl. 362/85

(57) ABSTRACT

A keypad lighting arrangement adapted to transmit at least a portion of light emitted from light sources through a keypad so as to facilitate visual recognition of information expressed on keypad members of a keypad includes light sources, a photoluminescent diffusion sheet arranged over the light sources and containing a photoluminescent material for converting light from the light sources and a light-diffusing material for diffusing emitted from the light sources, and a keypad member over the photoluminescent diffusion sheet, wherein the light sources emit blue wavelength light and the photoluminescent diffusion sheet absorbs at least a portion of the blue wavelength light and converts the blue wavelength of light to a different wavelength of light.

The present invention claims the benefit of Korean Patent Application No. 10-2005-0028463 filed in Korea on Apr. 6, 2005, which is hereby incorporated by reference in its entirety.

### BACKGROUND OF THE INVENTION

1. Field of the Invention

The present invention relates to keypad lighting arrangement, and more particularly to a keypad lighting arrangement that uses blue light emitting diodes (LEDs).

2. Description of the Related Art

In general, electronic devices, such as cellular phones, personal digital assistants (PDAs), remote controllers and players, include a keypad for receiving information keyed in by users. LEDs arranged at a back surface of the keypad emit light out of the keypad members of the electronic devices during the night time or in poorly illuminated places. This illumination through the keypad members assists users in the input of information.

FIG. 1a is an expanded perspective view of a related art keypad lighting in which blue LEDs are used and FIG. 1b is an expanded perspective view of a related art keypad lighting in which white LEDs are used. The blue LEDs of FIG. 1a and the white LEDs of 1b are arranged at predetermined intervals on circuit board 13, depending on the size of the keypad 12. FIG. 1c is a cross-sectional view of the related art keypad lighting shown in FIG. 1a FIGS. 1a, 1b and 1c show illumination systems employing a plurality of LEDs that emit a single fixed color. The color in such systems can not be changed by a user so there are no possible varieties of color for a user to choose.

In the past, blue LEDs have been used to emit only blue light. In the case where other colors are required, phosphor films are attached to the blue LEDs to convert the emitted blue light into other desired colors. Such phosphor films are respectively attached to each of the individual blue LEDs.

To improve luminance and ease of recognition of individual keypad members in the night time and in poorly illuminated places, white LEDs are employed in the related art instead of blue LEDs. The LEDs are arranged on a circuit board under the keypad at predetermined intervals depending on the size of the keypad. However, such an arrangement using white LEDs does not satisfy users' diverse tastes for optional different colors because the use of color filters with such white light LEDs substantially decreases the brightness of the output light. In addition, related art white LEDs are expensive. Because of these disadvantages, utilization of white LEDs in keypad lighting is poor despite the great demand for white light and other colors of light in the market.

### SUMMARY OF THE INVENTION

Accordingly, the present invention is directed to a keypad lighting arrangement that substantially obviates one or more of the problems due to limitations and disadvantages of the related art.

An object of the present invention is to provide a keypad lighting arrangement that includes blue LEDs, a keypad, and a photoluminescent diffusion sheet interposed therebetween to convert blue light emitted from the blue LEDs into another color of light, enabling a user to set a desired color.

Another object of the present invention is to provide a keypad lighting arrangement that includes blue LEDs, a keypad, and a photoluminescent diffusion sheet interposed therebetween to convert blue light emitted from the blue LEDs into different wavelengths of light and to control the luminance of the different wavelengths of light.

Another object of the present invention to provide a keypad lighting arrangement with high color purity and brightness that be produced at lower cost as compared to related art keypad lighting employing white LEDs.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, there is provided a keypad lighting arrangement adapted to transmit at least a portion of light emitted from light sources through a keypad so as to facilitate visual recognition of information expressed on keypad members of a keypad includes light sources, a photoluminescent diffusion sheet arranged over the light sources and containing a photoluminescent material for converting light from the light sources and a light-diffusing material for diffusing emitted from the light sources, and a keypad member over the photoluminescent diffusion sheet, wherein the light sources emit blue wavelength light and the photoluminescent diffusion sheet absorbs at least a portion of the blue wavelength light and converts the blue wavelength of light to a different wavelength of light.

In another aspect of the present invention, there is provided a keypad lighting arrangement including a keypad provided with keypad members, a circuit board having a plurality of light sources emitting a first wavelength of light, a resin sheet including a photoluminescent material and a light-diffusing material, wherein the photoluminescent material sheet absorbs at least a portion of the first wavelength of light and converts the first wavelength of light to a second wavelength of light different from the first wavelength of light, and a transparent dome sheet interposed between the circuit board and the resin sheet, the transparent dome sheet having contact keys.

In another aspect, a keypad lighting arrangement including a keypad having information expressed on keypad members, light sources emitting a first wavelength of light, photoluminescent materials for absorbing at least a portion of the first wavelength of light and converting the first wavelength of light to a different wavelength of light, and a dome sheet interposed between the keypad and the light sources, the dome sheet having contact keys and positioned to receive the first wavelength of light prior to the photoluminescent material absorbing at least a portion of the first wavelength.

It is to be understood that both the foregoing general description and the following detailed description are exemplary and explanatory and are intended to provide further explanation of the invention as claimed.

### BRIEF DESCRIPTION OF THE DRAWINGS

The above and other objects, features and other advantages of the present invention will be more clearly understood from the following detailed description taken in conjunction with the accompanying drawings, in which:

FIG. 1a is an expanded perspective view of a related art keypad lighting in which blue LEDs are used;

FIG. 1b is an expanded perspective view of a related art keypad lighting in which white LEDs are used;

FIG. 1c is a cross-sectional view of a related art keypad lighting unit shown in FIG. 1a;

FIG. 2 is a cross-sectional view schematically showing the structure of a photoluminescent diffusion sheet used in embodiments of the present invention;

FIG. 3 is an expanded perspective view of a keypad lighting arrangement according to embodiments of the present invention;

FIG. 4a is a cross-sectional view of a keypad lighting arrangement using a photoluminescent diffusion sheet according to a first embodiment of the present invention;

FIG. 4b is a cross-sectional view of a keypad lighting arrangement using a plurality of a photoluminescent diffusion sheets according to a second embodiment of the present invention;

FIG. 4c is a cross-sectional view of a keypad lighting arrangement according to a third embodiment of the present invention;

FIG. 4d is a cross-sectional view of keypad lighting arrangement according to a fourth embodiment of the present invention;

FIG. 5 is a graph comparing the spectrum of a keypad lighting arrangement in accordance with embodiments of the present invention in which a photoluminescent diffusion sheet is used with blue LEDs, with that of a related art lighting using white LEDs; and

FIG. 6 is a graph comparing the spectrum of a keypad lighting arrangement according to embodiments of the present invention in which a photoluminescent diffusion sheet is used with blue LEDs, with that of a related art keypad lighting using blue LEDs.

### DESCRIPTION OF THE PREFERRED EMBODIMENTS

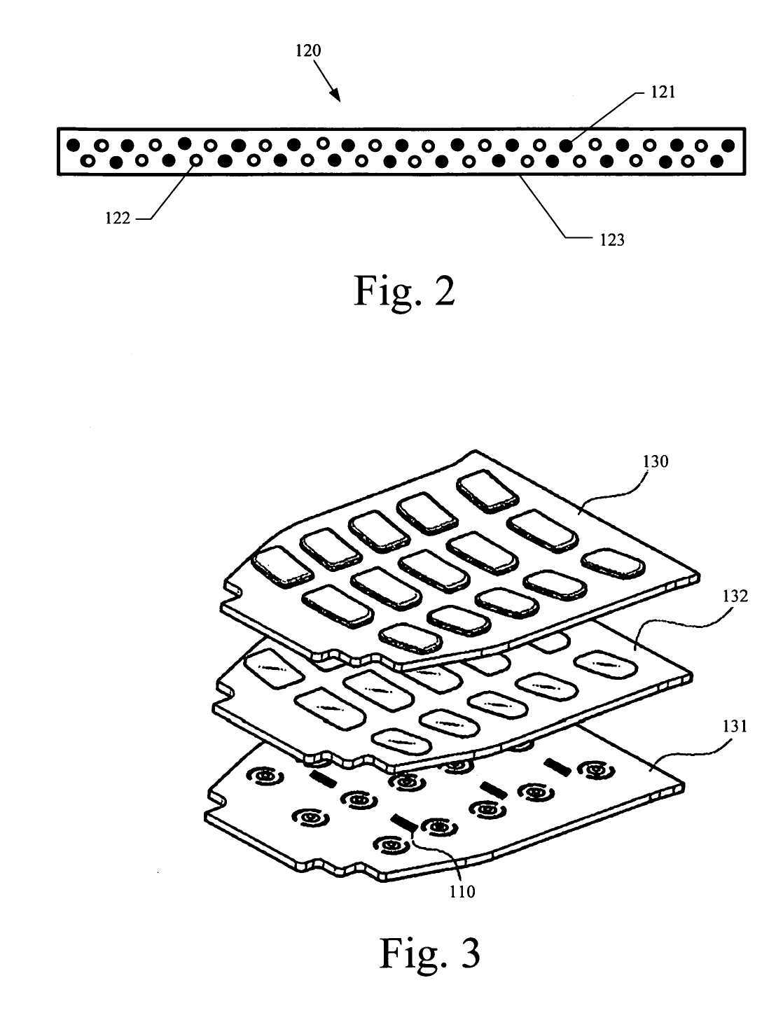

A keypad lighting arrangement in accordance with exemplary embodiments of the present invention will now be described in detail with reference to FIGS. 2-6. FIG. 2 is a cross-sectional view schematically showing the structure of a photoluminescent diffusion sheet in embodiments of the present invention. As shown in FIG. 2, a photoluminescent diffusion sheet 120 includes photoluminescent materials 121 for converting an input wavelength of light into an output wavelength of light having a different wavelength than the input wavelength of light, light-diffusing materials 122 for scattering and diffusing light, and a resin 123 serving as a matrix for holding the photoluminescent material and the light-diffusing material in uniform distribution. In addition to the photoluminescent and light-diffusing materials, precipitation-preventing agents, defoaming agents, a binder, or the like, can be added into the matrix to make the dispersion of the materials and particles uniform and to improve the moldability of the sheet during formation of the sheet.

Examples of the photoluminescent materials 121 used in embodiments of the present invention include inorganic fluorescent materials, organic fluorescent materials, organic pigments, nanomaterials, etc. An exemplary inorganic fluorescent material can be prepared by doping Y₃Al₅O₁₂ (YAG) as a garnet (Gd) material with cerium. Other specific examples of inorganic fluorescent materials that can be used in embodiments of the present invention include (Y_{1-x-y}GdₓCe_{y})₃(Al_{1-z}Ga_{z})₅O₁₂; (Gd₁₋ₓCeₓ)Sc₂Al₅O₁₂(where x+y≦1; 0≦x≦1; 0≦y≦1; 0≦z≦1); SrB₄O₇:Sₘ²⁺; SrGa₂S₄:Eu²⁺; BaMg₂Al₁₆O₂₇:Eu²⁺; (Sr,Mg,Ca,Ba,Zn)₂P₂O₇:Eu,Mn; (Ca,Sr,Ba,Mg)₅(PO₄)₃(Cl,F,OH):Eu,Mn; (Sr,Ca,Ba,Mg)₁₀(PO₄)₆(F,Cl,Br,OH):Eu²⁺; (Sr,Ca,Ba,Mg)₁₀(PO₄)₆(F,Cl,Br,OH):Eu²⁺,Mn²⁺; (Sr,Ba,Ca)MgAl₁₀O₁₇:Eu,Mn; (Ba,Sr,Ca)MgAl₁₀O₁₇:Eu²⁺; (Sr,Ca)₁₀(PO₄)₆·nB₂O₃:Eu²⁺(where 0<n<1); Sr₄Al₁₄O₂₅:Eu; 3.5MgO·0.5MgF₂·GeO₂:Mn⁴⁺; ZnS:Cu,Al; ZnS:Ag,Al; CaS:Ce; SrS:Ce; SrS:Eu; MgS:Eu; CaS:Eu; (Y,Tb,Lu,La,Gd)₃(Al,Sc,Ga,In)₅O₁₂:Ce,Pr,Sm; BaAl₈O₁₃:Eu; 2SrO·0.84P₂O₅·0.16B₂O₃:Eu; Sr₂Si₃O₈·2SrCl₂:Eu; Ba₃MgSi₂O₈:Eu²⁺; Sr₄Al₁₄O₂₅:Eu²⁺; (Ba,Sr,Ca)Al₂O₄:Eu²⁺; (Y,Gd,Lu,Sc,La)BO₃:Ce³⁺,Tb³⁺; (Ba,Sr,Ca)₂SiO₄:Eu²⁺; (Ba,Sr,Ca)₂(Mg,Zn)Si₂O₇:Eu²⁺; (Sr,Ca,Ba)(Al,Ga,In)₂S₄:Eu²⁺; (Y,Gd,Tb,La,Sm,Pr,Lu)ₓ(Al,Ga,In)_{y}O₁₂:Ce³⁺(where 2.8≦x≦3; 4.9≦y≦5.1); (Ca,Sr,Ba)₈(Mg,Zn)(SiO₄)₄(Cl,F)₂:Eu²⁺,Mn²⁺; (Gd,Y,Lu,La)₂O₃:Eu³⁺,Bi³⁺; (Gd,Y,Lu,La)₂O₂S:Eu³⁺,Bi³⁺; (Gd,Y,Lu,La)VO₄:Eu³⁺,Bi³⁺; SrY₂S₄:Eu²⁺; CaLa₂S₄:Ce³⁺; (Ca,Sr)S:Eu²⁺; (Ba,Sr,Ca)MgP₂O₇:Eu²⁺,Mn²⁺; ZnCdS; and mixtures thereof. These photoluminescent materials have different main emission wavelengths. Thus, mixtures thereof can yield a higher luminance white light having a more consistent spectrum of color.

Ce3+light emission is dependent on garnet compositions that may vary from green light (˜540 nm; YAG:Ga,Ce) to (˜600 nm; YAG:Gd,Ce) without decrease in light efficiency. Green inorganic fluorescent materials absorb light at 500 nm or less and emit light at a main wavelength of 535 nm. A representative inorganic fluorescent material for green light emission is SrGa2S4:Eu2+. A representative inorganic fluorescent material for blue light emission is BaMg2Al16O27:Eu2+. Blue inorganic fluorescent materials absorb light at 430 nm or less, and emit light at a main wavelength of 450 nm. Deep-red inorganic fluorescent materials absorb all visible rays at 600 nm or less and emit deep-red light having a wavelength of 650 nm or more. A representative inorganic fluorescent material for deep-red light emission is SrB4O7:Sm2+. SM2+mainly contributes to red light emission.

Organic fluorescent materials can also emit blue, green or red light. For example, representative organic materials for blue light emission are 4,4′-bis(2,2-diphenyl-ethen-1-yl)diphenyl (DPVBi), bis(styryl)amine (DSA)-based materials, etc. Representative organic materials for green light emission are tris(8-quinolinato)aluminum (III)(Alq₃), coumarin 6,10-(2-benzothiazolyl)-1,1,7,7-tetramethyl-2,3,6,7-tetrahydro-1H ,5H ,11H-[1]benzopyrano[6,7,8-ij]-quinolizin-11-one (C545T), quinacridone, etc. Representative organic materials for red light emission are 4-dicyanomethylene-2-methyl-6-julolidin-4-yl-vinyl)-4H-pyrane (DCM2), 4-(dicyanomethylene)-2-methyl-6-(1,1,7,7-tetramethyljulolidyl-9-enyl)-4H-pyrane (DCJT), 4-(dicyanomethylene)-2-t-butyl-6-(1,1,7,7-tetamethyljulolidyl-9-enyl)-4H-pyrane (DCJTB), and the like.

Examples of organic pigments that can be used in embodiments of the present invention include azo-based pigments, e.g., insoluble azo pigments, azo lake pigments, condensed azo pigments and chelated azo pigments; phthalocyanine-based pigments, e.g., copper phthalocyanines, halogenated copper phthalocyanines, metal-free phthalocyanines and copper phthalocyanine lake pigments; dye lake pigments, e.g., acidic dye lake pigments and basic dye lake pigments; condensed polycyclic pigments, e.g., anthraquinone, thioindigo, perylene, perinone, quinacridone, dioxazine, isoindolinone, isoindoline and quinaphthalone; and other pigments, e.g., nitroso pigments, alizarin, azomethine metal complexes, aniline black, alkali blue and flame fluorescent materials.

As materials for nanometals and composite quantum dots, nano-scale metals and nanocomposite materials can be used in embodiments of the present invention. As the nanometals, there can be used, for example, platinum, gold, silver, nickel, magnesium, and palladium. As the nanocomposite materials, there can be mentioned cadmium sulfide (CdS), cadmium selenide (CdSe), zinc sulfide (ZnS), zinc selenide (ZnSe), indium phosphite (InP), titanium oxide (TiO₂), zinc oxide (ZnO), tin oxide (SnO), silicon oxide (SiO₂), magnesium oxide (MgO), and others.

The light-diffusing materials 122 having a function to uniformly diffuse light is largely divided into a transparent diffusing agent and a white diffusing agent. Together, the transparent and white diffusing agents work together to diffuse both the input wavelength of light to the photoluminescent materials 121 and output wavelength of light from the photoluminescent materials. Examples of transparent diffusing agents that can be used in embodiments of the present invention include organic transparent diffusing agents, such as acrylic, styrene and silicone resins, and inorganic transparent diffusing agents, such as synthetic silica, glass beads and diamond. Representative examples of white diffusing agents that can be used in embodiments of the present invention include organic metal oxides, such as silicon oxide (SiO₂), titanium oxide (TiO₂), zinc oxide (ZnO), barium sulfate (BaSO₄), calcium carbonate (CaSO₄), magnesium carbonate (MgCO₃), aluminum hydroxide (Al(OH)₃), clay, and the like.

Examples of the resin acting as a matrix for the photoluminescent material 121 and the light-diffusing material 122 include epoxy, silicone, urethane, acrylic, PET, polyvinyl chloride, polyester, polycarbonate, vinyl, methacrylic ester, polyamide, synthetic rubber, polystyrene, CBS, polymethylnethacrylate, fluorine, polyethylene, polypropylene, ABS, ferra based resins, and others.

A precipitation-preventing agent for preventing precipitation of the photoluminescent material 121 and the light-diffusing material 122, a defoaming agent for preventing foaming, a binder, and the like, may be added during formation of a uniform film containing the photoluminescent materials 121, the light-diffusing materials 122 and the resin.

The production of the photoluminescent diffusion sheet 120 can be performed by molding, extrusion, exclusion, suspension printing, hot-roll coating, heat plate-type coating, cold-type coating, screen printing, dip coating, spray coating, spin coating, doctor blade, extrusion molding, transfer, lamination, injection molding, blow molding, calendering, casting, FRP molding, heat molding, welding, and other techniques. Among these, extrusion molding and screen printing are preferred.

The photoluminescent diffusion sheet 120 in embodiments of the present invention can be produced in accordance with the following procedure. First, a synthetic resin is melted. A Photoluminescent materials 121, light-diffusing materials 122, precipitation-preventing agents, defoaming agents and a binder are then added to the molten synthetic resin. Thereafter, the mixture is uniformly stirred.

Rapid cooling in a molten state lowers the degree of crystallization of the mixture to produce a film having superior moldability. The appearance of the film, in terms of crystallization, crystal size and crystal structure, has a great influence on the characteristics of the film. The strength, impermeability and chemical resistance of the film are determined by the crystallization rate. The toughness and flexibility of the film are determined by the amorphous sections of the film.

Cooling rate greatly affects the crystallization of the film. Slow cooling in a molten state leads to a high degree of crystallization. The produced film has a low ductility but has superior impermeability and high strength. Post-processing further affects the crystallization of the film, for example, heat molding or stretching can further improve the degree of crystallization of the film.

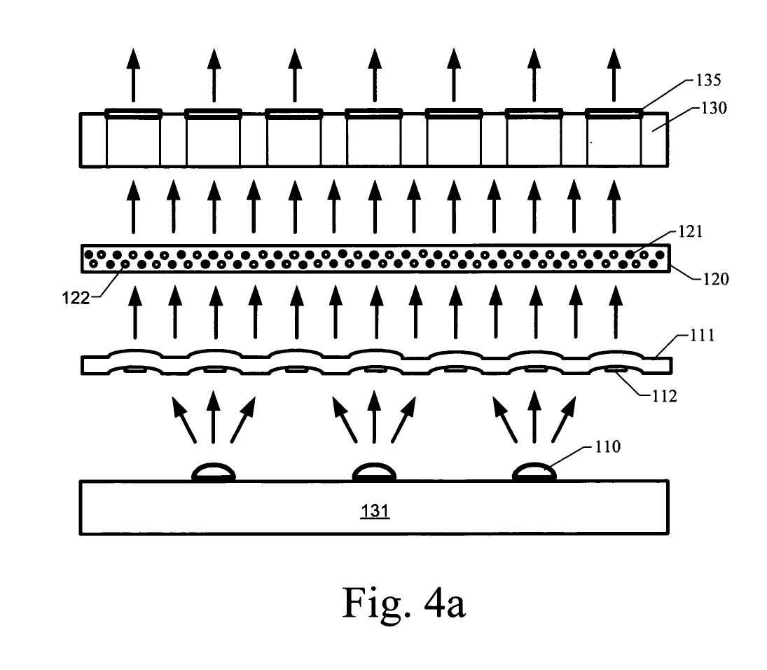

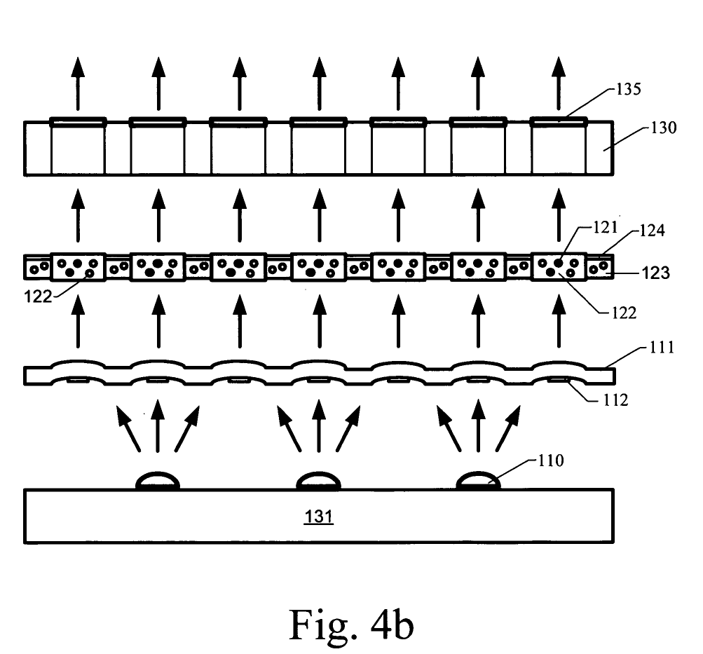

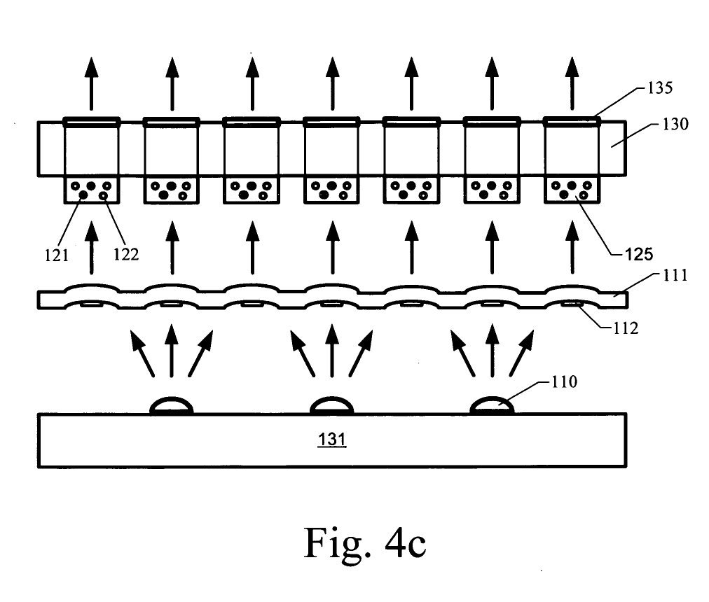

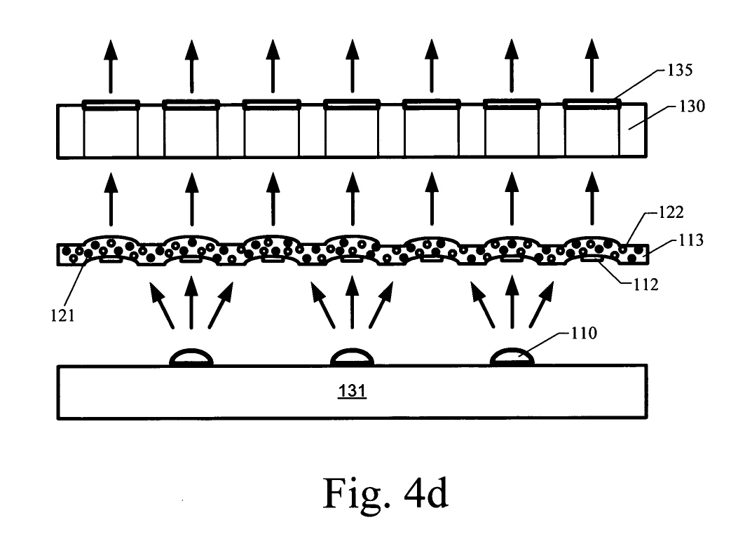

A detailed description will be made to more fully explain exemplary embodiments of a keypad lighting arrangement of the present invention that uses a photoluminescent diffusion sheet with reference to FIGS. 3, 4a, 4b and 4c.

FIG. 3 shows a keypad lighting arrangement for an electronic device including blue LEDs 110 as light sources on a circuit board 131, a color control sheet 132 and a keypad 130 according to embodiments of the present invention. The color of the keypad lighting arrangement can be controlled or determined by adjusting fluorescent materials used in the color control sheet 130. FIG. 4a is a cross-sectional view of a keypad lighting arrangement using a color control sheet according to a first embodiment of the present invention.

FIG. 4a shows a structure of the keypad lighting arrangement for an electronic device including blue LEDs 110 as light sources on a circuit board 131, and a photoluminescent diffusion sheet 120 for color conversion and diffusion of light. A transparent dome sheet 111 is interposed between the circuit board 131 and the a photoluminescent diffusion sheet 120. The transparent dome sheet 111 has contact keys positioned corresponding to respective key contact points (not shown) of the circuit board 131. When a user presses a keypad member 135 of the keypad 130, the contact point of the transparent dome 111 for the respective keypad member 135 comes into contact with the key contact point of the circuit board 131 due to pressure transmitted through the photoluminescent diffusion sheet 120 and thus the signal corresponding to the keypad member is recognized. Further, blue wavelength light emitted from the blue LEDs 110 penetrates through the transparent dome sheet 111, and the photoluminescent diffusion sheet 120 absorbs at least a portion of the blue wavelength light and converts the blue wavelength light to a different wavelength light so as to facilitate visual recognition of information expressed on a keypad member 135.

A portion of blue light entering the photoluminescent diffusion sheet 120 penetrates through the photoluminescent diffusion sheet 120, and the rest of the blue light is converted to light of various colors, including green, yellow and red, by the photoluminescent materials 121 present in the photoluminescent diffusion sheet 120. In addition, both the blue light and the converted light is scattered and diffused by the light-diffusing materials 122 present in the photoluminescent diffusion sheet 120, thereby improving the uniformity of all of the light emitted from the photoluminescent diffusion sheet 120. The light emitted from the photoluminescent diffusion sheet 120 is white light having good color purity. To further improve luminance, the scattered and diffused light emitted from the photoluminescent diffusion sheet 120 can be refracted and collected by other optical sheets between the photoluminescent diffusion sheet 120 and the keypad 301.

Because different photoluminescent diffusion sheets 120 can emit different colors, a user can change the color of light emitted through the keypad by changing the photoluminescent diffusion sheet 120. In the alternative, the photoluminescent diffusion sheet 120 can be formed integrally on the keypad 301 by directly printing the photoluminescent diffusion sheet 120 onto the keypad 130. If the photoluminescent diffusion sheet 120 is formed integrally on the keypad 130, both the keypad 130 and the photoluminescent diffusion sheet 120 are changed together to change the color of light emitted through the keypad 130. In another alternative, the photoluminescent diffusion sheet 120 can be formed integrally on the transparent dome sheet 111 by directly printing the photoluminescent diffusion sheet 120 onto the transparent dome sheet 111. If the photoluminescent diffusion sheet 120 is formed integrally on the transparent dome sheet 111, both the keypad 130 and the transparent dome sheet 111 are changed together to change the color of light emitted through the keypad 130.

FIG. 4b is a cross-sectional view of a keypad lighting arrangement according to a second embodiment of the present invention. More particularly, the keypad lighting arrangement in FIG. 4b includes a plurality of photoluminescent diffusion sheets 122 in which each of the photoluminescent diffusion sheets 122 corresponds to a keypad member 135 of the keypad 130. The photoluminescent diffusion sheets 122 can be the same shape as the keypad members 135 through which light from the blue LEDs 110 on the circuit board 131 is emitted.

As shown in FIG. 4b, individual photoluminescent diffusion sheets 122 can be positioned for each keypad member 130, leading to a reduction in the production cost of the photoluminescent diffusion sheet because a smaller area in size of photoluminescent diffusion sheets 122 are needed as compared to the area of the single photoluminescent diffusion sheet 120 used in the first embodiment shown in FIG. 4a. The photoluminescent diffusion sheets 122 can be held in position using a retaining sheet 123. The individual photoluminescent diffusion sheets 122 can either be the same color or different colors. The light-diffusing material 122 can also be placed in the retaining sheet 123 such that retaining sheet diffuses light to the photoluminescent diffusion sheets 122. Further, an opaque layer 124 can be formed on the retaining sheet such that no light leakage occurs. A transparent dome sheet 111 is interposed between the circuit board 131 and the a photoluminescent diffusion sheets 122 in the retaining sheet 125.

The different photoluminescent diffusion sheets in the retaining sheet can emit different colors. Further, a user can change the color of light emitted through the keypad by changing the retaining sheet to another retaining sheet having photoluminescent diffusion sheets that emit a different color. As described above in the first embodiment, when a user presses a keypad member 135 of the keypad 130, the contact point of the transparent dome 111 for the respective keypad member 135 comes into contact with the key contact point of the circuit board 131 due to pressure transmitted through the photoluminescent diffusion sheets 122 and thus the signal corresponding to the keypad member is recognized.

FIG. 4c is a cross-sectional view of a keypad lighting arrangement according to a third embodiment of the present invention. More specifically, FIG. 4c shows a keypad lighting arrangement in which photoluminescent diffusion sheet 113 containing both a photoluminescent material 121 and a light diffusing material 122 that are respectively formed on just the bottom surfaces of the keypad members 135 of the keypad 130. For example, the photoluminescent diffusion sheets 125 can be directly printed on the bottom surfaces of the keypad members. As in FIG. 4a, light emitted from the blue LEDs 101 penetrates through the printed photoluminescent diffusion sheets 125 on the bottom surfaces of the keypad members 135, achieving production of various colors and improved luminance for each of the keypad members 135 depending on the color that each of the respective photoluminescent diffusion sheets 125 is configured to emit. For example, individual keypad members 135 or groups of the keypad members 135 can be configured to emit a specific color depending on the photoluminescent diffusion sheet 125 used for each keypad member 135. A user can change the color of light emitted through a keypad member 135 by changing the keypad 130. A transparent dome sheet 111 is interposed between the circuit board 131 and the keypad 130 with the keypad members 135 having the photoluminescent diffusion sheets 125 thereon.

FIG. 4d is a cross-sectional view of a keypad lighting arrangement according to a fourth embodiment of the present invention. More specifically, FIG. 4d shows a keypad lighting arrangement in which photoluminescent diffusion sheet 113, containing both a photoluminescent material 121 and a light diffusing material 122, also functions as a dome sheet that has contact keys 112 positioned corresponding to respective key contact points (not shown) on the circuit board 131. Thus, the photoluminescent diffusion sheet 113 absorbs at least a portion of the blue wavelength light and converts the blue wavelength light to a different wavelength light so as to facilitate visual recognition of information expressed on a keypad member 135, and when a user presses a keypad member 135 of the keypad 130, the contact point of the photoluminescent diffusion sheet 113 for the respective keypad member 135 comes into contact with the key contact point of the circuit board 131 due to pressure transmitted through the photoluminescent diffusion sheets 122 and thus the signal corresponding to the keypad member is recognized.

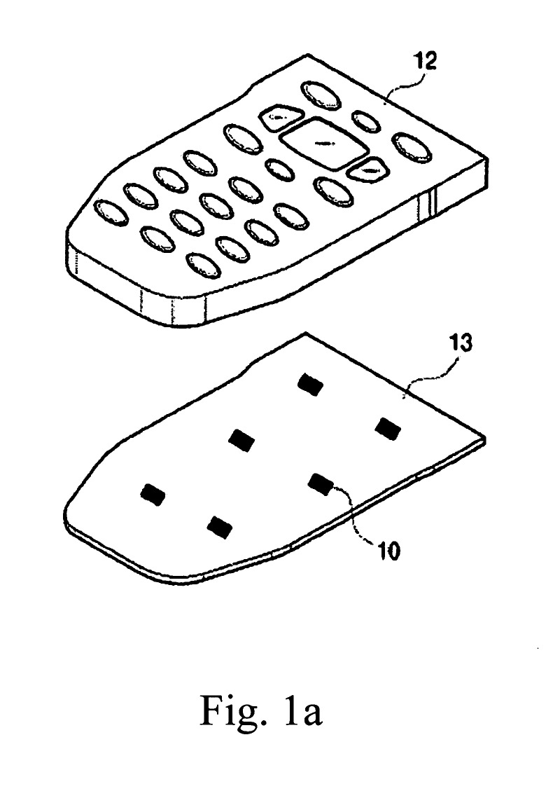

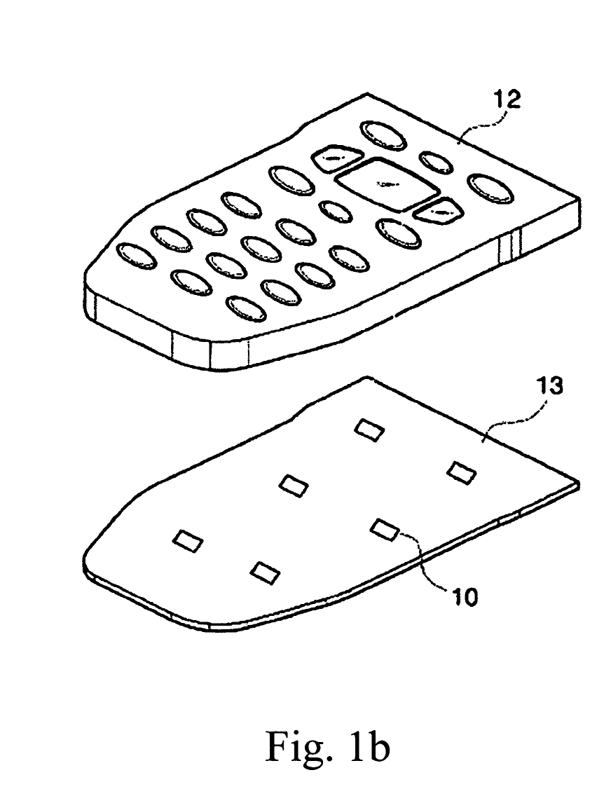

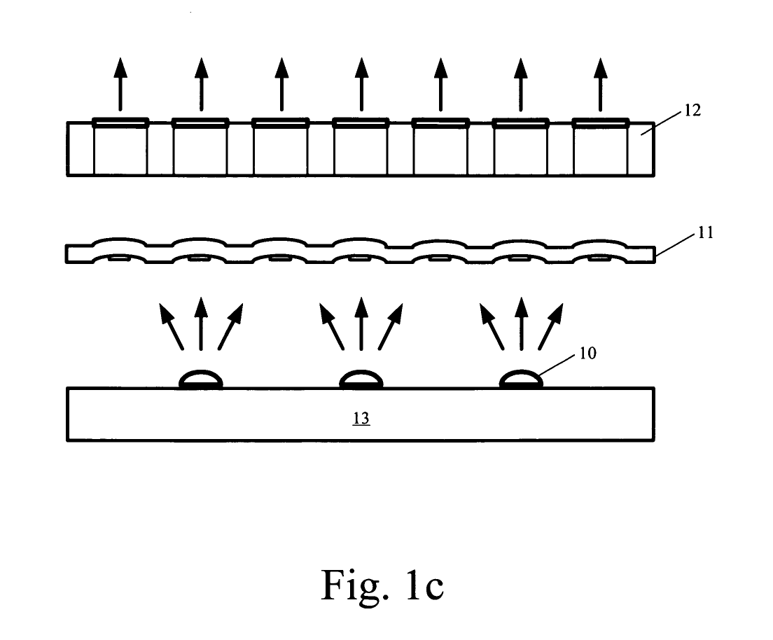

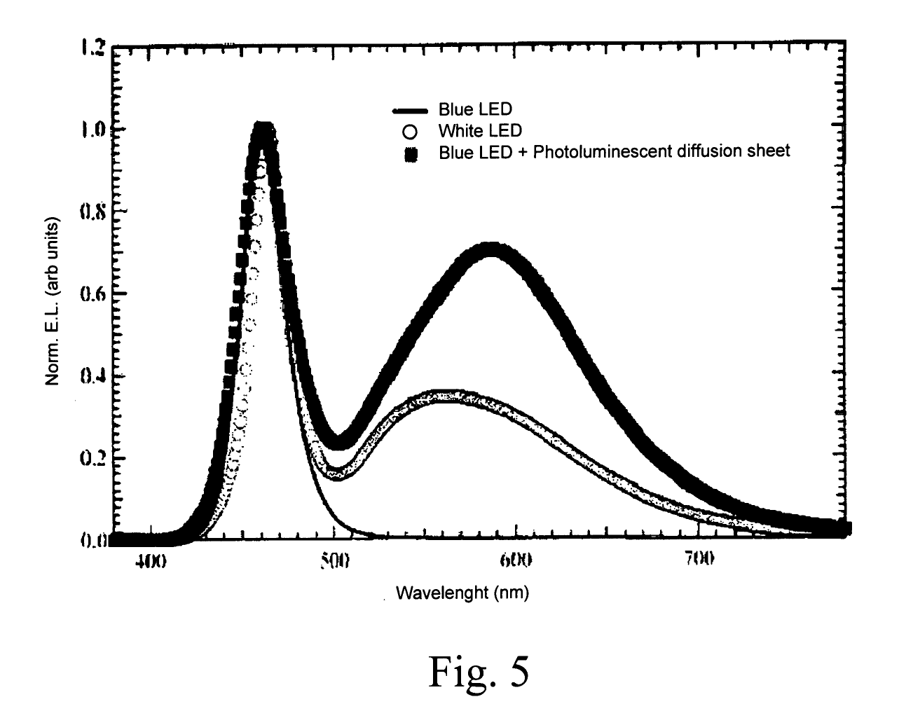

FIG. 5 is a graph comparing the spectrum of the keypad lighting shown in FIG. 3 according to embodiments of the present invention using a photoluminescent diffusion sheet as compared to the related art keyboard lighting using white LEDs, CS-1000A, manufactured by Minolta shown in FIG. 1. The related art keypad lighting uses complementary light at main wavelengths of about 460 nm and about 560 nm. In contrast, the keypad lighting arrangement in embodiments of the present invention employs blue LEDs as light sources and a photoluminescent diffusion sheet produced from a mixture of inorganic fluorescent materials, such as YAG, SrS:Eu, SGa₂S₄:Eu, Y₃Al₅O₁₂:Ce, (YGd)₃Al₅O₂:Ce and ZnCdS. The keypad lighting arrangement in embodiments of the present invention has main wavelengths of 460 nm and 590 nm, and contains more green and red light than the related art lighting, achieving production of various colors, improved luminance and uniform luminance of the keypad.

A great deal of research has been conducted to improve the color reproducibility of keypad lightings. It has been found that an increase in the output of an inorganic LED results in deterioration of a fluorescent material distributed in a molding part. Thus, it is difficult to introduce a fluorescent material of various colors around the inorganic LED chip. Since the photoluminescent diffusion sheet used in embodiments of the present invention is configured in such a way that it is separated from the light sources, the above problem is resolved. This is supported by the spectral results shown in FIG. 5 of the keypad lighting arrangement according to the present invention.

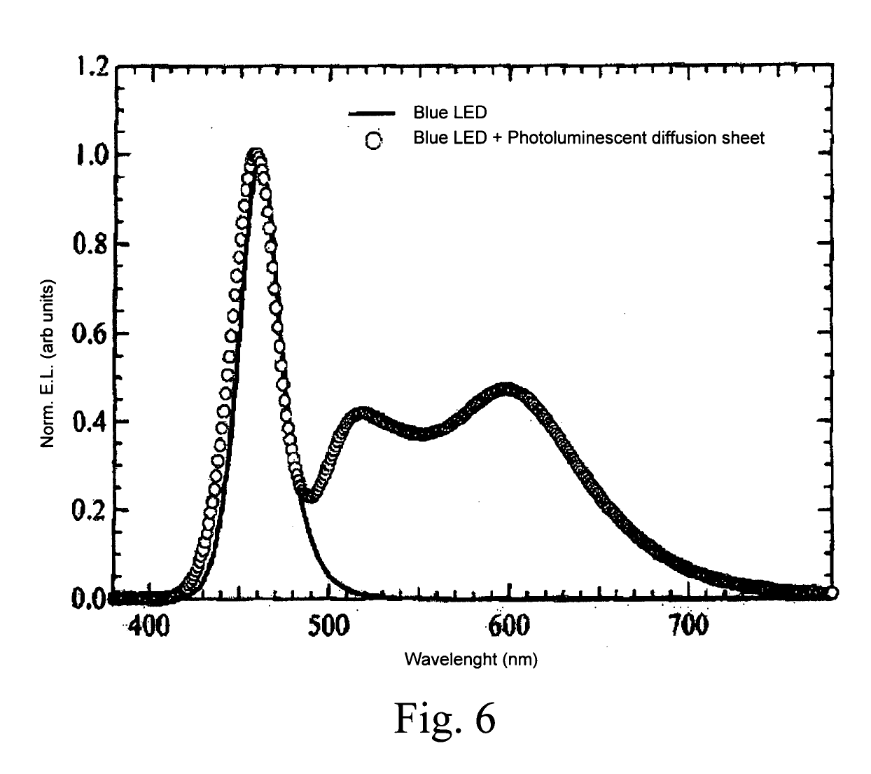

FIG. 6 shows the spectrum of the keypad lighting arrangement shown in FIG. 3 in which the photoluminescent diffusion sheet is produced using a mixture of SrS:Eu, SGa₂S₄:Eu, Y₃Al₅O₁₂:Ce, (YGd)₃Al₅O₁₂:Ce and ZnCdS with a controlled mixing ratio as an inorganic fluorescent material (ZnCdS), instead of an organic fluorescent material (DCJTB). The spectrum in FIG. 6 shows that the keypad lighting arrangement of the present invention emits three-wavelength white light of about 460 nm (blue), about 520 nm (green), and about 600 nm (red). The spectral results shown in FIG. 6 indicate that the keypad lighting arrangement according to the present invention has no problem in the light emission, irrespective of the use of the organic fluorescent material or the inorganic fluorescent material.

As can be seen from the results shown in FIGS. 5 and 6, the photoluminescent diffusion sheet used in the present invention can solve the problems of the related art keypad lighting, such as difficult introduction of a fluorescent material capable of producing various colors due to the deterioration of the fluorescent material. In addition, the keypad lighting of the present invention can achieve the production of various colors and improved luminance of the light for a keypad. As apparent from the spectrum of the keypad lighting arrangement according to the present invention in which the photoluminescent diffusion sheet is used, the keypad lighting arrangement according to the present invention emits light of blue, green and red wavelengths at a uniform level, indicating high color reproducibility.

As apparent from the above description, the present invention provides the following advantages. First, the use of the photoluminescent diffusion sheet in the keypad lighting arrangement in embodiments of the present invention allows the use of blue LEDs, instead of white LEDs, so as to reduce production costs. Second, by using the photoluminescent diffusion sheet of the present invention, the keypad lighting arrangement in embodiments of the present invention can be produced by a simplified procedure at low costs. In addition, selection of suitable photoluminescent materials used in the production of the photoluminescent diffusion sheet makes it possible to produce light of wavelengths and colors corresponding to the needs of consumers and to improve the luminance of the keypad lighting arrangement. Third, colors of the keypad lighting arrangement for illuminating keypads of various electronic devices can be varied, thus offering superior design. In addition, colors for the keypad of an operating electronic devices can be changed to desired colors by changing the kind of the photoluminescent diffusion sheet containing two or more materials.

It will be apparent to those skilled in the art that various modifications and variations can be made in the keypad lighting arrangement of the present invention without departing from the spirit or scope of the invention. Thus, it is intended that the present invention cover the modifications and variations of this invention provided they come within the scope of the appended claims and their equivalents.

What is claimed is:

1. A keypad lighting arrangement adapted to transmit at least a portion of light emitted from light sources through a keypad so as to facilitate visual recognition of information expressed on keypad members of a keypad, comprising:
light sources;
a photoluminescent diffusion sheet arranged over the light sources and containing a photoluminescent material for converting light from the light sources and a light-diffusing material for diffusing emitted from the light sources; and
a keypad member over the photoluminescent diffusion sheet, wherein the light sources emit blue wavelength light and the photoluminescent diffusion sheet absorbs at least a portion of the blue wavelength light and converts the blue wavelength of light to a different wavelength of light.

2. The keypad lighting arrangement according to claim 1, wherein the photoluminescent diffusion sheet corresponds to a single keypad member.

3. The keypad lighting arrangement according to claim 2, wherein the photoluminescent diffusion sheet is integrally formed on the keypad.

4. The keypad lighting arrangement according to claim 1, wherein the photoluminescent diffusion sheet is printed on the bottom surface of the keypad member.

5. The keypad lighting arrangement according to claim 1, wherein a plurality of the keypad members are formed together as a keypad and the photoluminescent diffusion sheet is integrally formed on the keypad.

6. The keypad lighting arrangement according to claim 1, wherein a plurality of the keypad members are formed together as a keypad and the photoluminescent diffusion sheet is directly printed on the keypad.

7. The keypad lighting arrangement according to claim 1, wherein the light sources are blue LEDs.

8. The keypad lighting arrangement according to claim 1, wherein the photoluminescent diffusion sheet contains photoluminescent and light-diffusing materials.

9. The keypad lighting arrangement according to claim 1, further comprising a transparent dome sheet interposed between the light sources and the photoluminescent diffusion sheet, the transparent dome sheet having contact keys.

10. A keypad lighting arrangement, comprising:
a keypad provided with keypad members;
a circuit board having a plurality of light sources emitting a first wavelength of light;
a resin sheet including a photoluminescent material and a light-diffusing material, wherein the photoluminescent material sheet absorbs at least a portion of the first wavelength of light and converts the first wavelength of light to a second wavelength of light different from the first wavelength of light; and
a transparent dome sheet interposed between the circuit board and the resin sheet, the transparent dome sheet having contact keys.

11. A keypad lighting arrangement, comprising:
a keypad having information expressed on keypad members;
light sources emitting a first wavelength of light;
photoluminescent materials for absorbing at least a portion of the first wavelength of light and converting the first wavelength of light to a different wavelength of light; and
a dome sheet interposed between the keypad and the light sources, the dome sheet having contact keys and positioned to receive the first wavelength of light prior to the photoluminescent material absorbing at least a portion of the first wavelength.

12. The keypad lighting arrangement of claim 11, further comprising:
light-diffusing materials for diffusing light emitted from the light sources.

13. The keypad lighting arrangement of claim 12, wherein the light-diffusing materials and the photoluminescent materials are distributed in a resin.

14. The keypad lighting arrangement of claim 13, wherein the resin is silicone.

15. The keypad lighting arrangement of claim 11, wherein the photoluminescent materials are in the dome sheet.

16. The keypad lighting arrangement of claim 15, wherein light-diffusing materials for diffusing light emitted from the light sources are in the dome sheet.

17. The keypad lighting arrangement of claim 11, wherein photoluminescent materials are in a resin sheet between the dome sheet and the keypad.

18. The keypad lighting arrangement according to claim 17, wherein the resin sheet corresponds to a single keypad member.

19. The keypad lighting arrangement according to claim 18, wherein the resin sheet is integrally formed on the keypad.

20. The keypad lighting arrangement according to claim 17, wherein the resin sheet is printed on the bottom surface of a keypad member and has a shape corresponding to the shape of the keypad member.
